(19) United States
(12) Patent Application Publication
(10) Pub. No.: US 2024/0255662 A1
(43) Pub. Date: Aug. 1, 2024

(54) SCALABLE TELECOMMUNICATIONS GEOTECHNICAL SURVEYING

(71) Applicant: Fiber Sense Limited, Mosman (AU)

(72) Inventor: Nathaniel J. LINDSEY, Oakland, CA (US)

(21) Appl. No.: 18/634,720

(22) Filed: Apr. 12, 2024

Related U.S. Application Data
(63) Continuation of application No. PCT/US2022/077880, filed on Oct. 11, 2022.
(60) Provisional application No. 63/256,079, filed on Oct. 15, 2021.

(51) Int. Cl. G01V 1/28; G01V 1/18; G01V 1/30

(52) U.S. Cl. CPC G01V 1/282; G01V 1/181; G01V 1/303

(57) ABSTRACT

A method of generating a geotechnical survey of a target area includes measuring DFOS data in an optical fiber located within a sensing distance of the target area and determining subterranean characteristics of the target area based on the measured DFOS data. A geotechnical surveying system may include an optical fiber and a DFOS device and a processor configured to calculate geotechnical data based on DFOS data.

### RELATED APPLICATION

This application is a continuation of International Patent Application No. PCT/US22/77880, titled “Scalable Telecommunications Geotechnical Surveying,” filed Oct. 11, 2022, which claims the benefit of U.S. Provisional Application No. 63/256,079, filed Oct. 15, 2021, each of which is incorporated herein by reference in its entirety.

### BACKGROUND

The physical properties of the near surface (upper 10-300 m of the Earth's crust) are important for safe construction of new infrastructure. Geotechnical surveys are common in urban and rural regions as well as offshore regions worldwide. For example, building engineers design structures with consideration of the site grade, the soil strength that must support the footings of the building, the potential need for fill to retrofit the foundation, and the saturated or unsaturated character of the subsurface. Geotechnical surveys are used in new building construction permits and due diligence processes to help property owners to follow safe building practices.

Geotechnical surveys are also important for seismic and liquefaction hazard analysis in the earthquake prone regions of the planet, such as the Western US, Mexico, Central and South America, the Caribbean Islands, New Zealand, Japan, Indonesia, Malaysia, Thailand, Taiwan, India, Italy, Turkey and Greece. In a geotechnical seismic site survey, the aim is to evaluate the physical properties of the near surface in order to characterize the risks posed by future larger magnitude earthquakes and high amplitude ground motion scenarios. When an earthquake occurs, zones of thick and unconsolidated soil experience an amplified degree of ground shaking because of the manner in which the seismic waves produced by earthquakes become trapped in the shallow subsurface soil layer. This reverberation causes ground motion amplification, which has been repeatedly shown to be 5-20 times compared with neighboring zones that have more compacted near surface, or where bedrock outcrops at the surface such that here is no sediment layer.

Near surface property characteristics are often described either in geological terms, such as rock and/or soil type, layer thicknesses, and water table depth (e.g., “a 5 meter thick sandlayer above bedrock”) or using physical and material parameters such as density, porosity, shear modulus, bulk modulus, Poisson's ratio, and saturation. One way to communicate near surface property information or the results of a geotechnical survey is in 1-D (vertical) property profiles between identified points on the surface, or in 2-D “cross-sectional” image diagrams which connect multiple vertical profiles in order to show lateral variability of properties along identified lines at the surface.

Near surface properties can be assessed using different technologies. The most detailed property information is typically obtained from using a drilling machine to extract a deep vertical core through the full section of interest of the near surface at the site of interest. Core samples can then be visually assessed by hand and layer depths and rock types can be directly measured. This method provides actual “ground truth” at the site of the core hole, but is intrusive, often requires intensive permitting, can be logistically difficult or impossible to maneuver into confined urban areas because of the size of the drill rig, commonly takes multiple weeks to complete drilling, and hence has a very large project expense. In the construction of new offshore infrastructure, drill core samples are even more difficult to obtain. But the central problem with drilling to obtain near surface property information is that the information varies laterally. In several regions, shallow soil thicknesses must be sampled every 10 to 100 meters horizontally in order to capture the degree of complexity required. Therefore, drill cores analysis may be useful at one 100 m×100 m area, but is impractical and expensive over larger regions, such as urban areas with a footprint of 10,000 m×10,000 m.

A different way to obtain near surface property information by non-intrusive means is to apply a geophysical method such as seismic imaging to probe the subsurface structure and materials. Seismic imaging involves deploying a collection of seismometers/geophones devices at the surface and setting off an active controlled source such as an explosive, Betsy gun, or using a VibroSeis truck. In seismic imaging, common inertial seismometers, accelerometers, and/or hydrophones are deployed at the surface and a seismic source is detonated creating the input seismic wave energy needed for the experiment. Much like X-ray or other forms of medical imaging, seismic imaging uses principles of reflection and refraction to characterize material properties in the subsurface according to their seismic wave velocity, and by comparing with well-established material characteristics, can be used to retrieve the profiles of near surface properties. This type of technique has been applied for geotechnical site surveying since the 1960's. The advantages of using geophysics over drilling for geotechnical surveying is that a seismic survey is non-invasive, can be deployed rapidly and conducted in hours to at most a few days covering a 1,000 m×1,000 m area, and can be designed to provide lateral characteristics (2D information) as well as 1-D profiles. The limitations of geophysical surveys, particularly in urban areas and offshore, are that the surveys can be difficult to permit due to the need of a large seismic source in an urban area or underwater where there are marine mammals. Therefore, there are needs for a non-intrusive geotechnical surveying method that overcomes the challenges described above, among others.

### SUMMARY

Embodiments of the present disclosure provide methods, systems, and devices that perform geotechnical surveying free from the disadvantages noted above. In particular, the present disclosure addresses the difficulties in geotechnical surveying by providing a system and method to obtain geophysical geotechnical survey information at scale in urban areas or offshore using one or many distributed optical fiber sensing systems deployed over telecommunications networks in a city or offshore region, a technique referred to as scalable telecommunications geotechnical surveying.

In embodiments of the systems and methods in accordance with disclosed embodiments, the principle of seismic wavefield correlation analysis is applied to extract coherent seismic signals from the background natural and/or anthropogenic seismological activity commonly present in urban areas. The ultimate sources of this background seismological activity may include electricity generators, hydrological pumps, agricultural equipment, acoustic alarms, construction and excavation equipment, vehicles, pedestrians, animals, wind, rain, earthquakes, storms, and ocean waves. It will be understood that multiple such activities may generate the background seismic energy that is used to conduct geotechnical surveying according to the present disclosure.

Methods are disclosed to determine how to conduct this type of survey in an offshore region and in an urban region, with parameters that improve accuracy and efficiency of conducting the surveys. Various parameters may determine likelihood of survey quality utilizing a priori information. Various methods may supplement survey regions of poor quality with artificial seismic sources, to supplement the natural and/or anthropogenic seismic sources.

The disclosed devices, systems, and methods obtain near surface property information in a continuous and efficient manner at scale across an entire city or along an optical fiber cable laid on the seafloor (e.g., extending 50 km or more). The output can be a model of the subsurface properties that describes the subsurface structure in a 1-dimensional sense (vertical profiles), 2-dimensional sense (cross-sectional images), or 3-dimensional sense (volumetric/layered models). This is accomplished efficiently without the typical fieldwork demanded of geophysical geotechnical surveying. This type of survey can be conducted in a repeated fashion over long durations of years to decades.

### BRIEF DESCRIPTION OF THE DRAWINGS

Embodiments will hereinafter be described in detail below with reference to the accompanying drawings, wherein like reference numerals represent like elements. The accompanying drawings have not necessarily been drawn to scale. Some of the figures may have been simplified by the omission of selected features for the purpose of more clearly showing other underlying features. Such omissions of elements in some figures are not necessarily indicative of the presence or absence of particular elements in any of the exemplary embodiments, except as may be explicitly disclosed in the corresponding written description.

FIG. 1A illustrates an example of a DFOS instrument sending and receiving laser light according to embodiments of the disclosed subject matter.

FIG. 1B illustrates an example of a geographical region with fiber optic infrastructure according to embodiments of the disclosed subject matter.

FIG. 2 illustrates an example of an algorithm workflow according to embodiments of the disclosed subject matter.

FIG. 3 illustrates an example of an algorithm workflow for recording DFOS data according to embodiments of the disclosed subject matter.

FIG. 4 illustrates an example of an algorithm workflow for verifying DFOS data quality according to embodiments of the disclosed subject matter.

FIG. 5 illustrates an example of an algorithm workflow for processing DFOS data according to embodiments of the disclosed subject matter.

FIG. 6 illustrates an example of an algorithm workflow for picking seismic phases according to embodiments of the disclosed subject matter.

FIG. 7 illustrates an example of an algorithm workflow for modeling a subsurface environment according to embodiments of the disclosed subject matter.

FIG. 8 illustrates an example of a conceptual representation of background seismological activities and subsurface geotechnical information according to embodiments of the disclosed subject matter.

FIG. 9 illustrates an example of geotechnical survey characteristics according to embodiments of the disclosed subject matter.

FIG. 10 illustrates an example of seismic noise recorded along a fiber optic cable and representing DFOS data according to embodiments of the disclosed subject matter.

FIGS. 11A-11B illustrate examples of extraction of coherent seismic waves from recorded seismic noise according to embodiments of the disclosed subject matter.

FIGS. 12A-12C illustrate examples of intermediate processing results based on the extracted coherent seismic waves from DFOS data according to embodiments of the disclosed subject matter.

FIG. 13 illustrates an example of a velocity vs. depth result obtained from the processed DFOS data at one position along an optical fiber according to embodiments of the disclosed subject matter.

FIG. 14 illustrates an example of a 2D model of a geotechnical survey according to embodiments of the disclosed subject matter.

FIG. 15 illustrates an exemplary relationship between wave velocity and rock types according to embodiments of the disclosed subject matter.

FIG. 16 illustrates conceptually how velocity is translated into soil type according to embodiments of the disclosed subject matter.

### DESCRIPTION OF IMPLEMENTATIONS

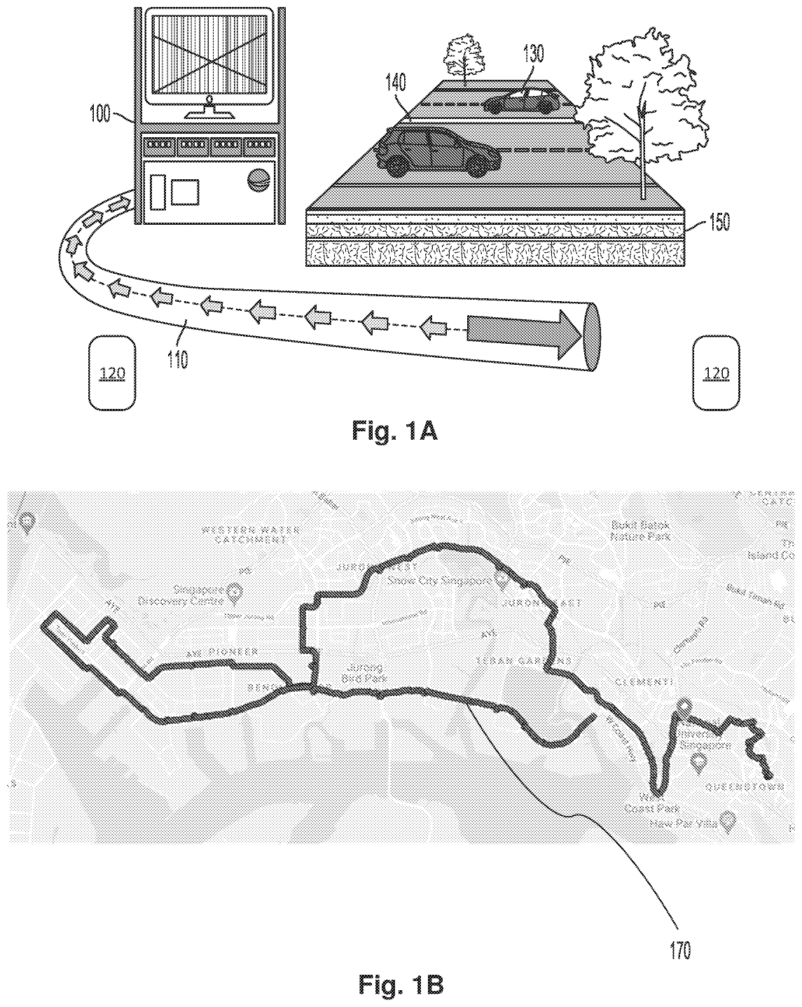

Referring to FIG. 1A, A DFOS instrument 100 shines a light into an optical fiber 150 and records the energy 110 returning as a function of time. As shown in FIG. 1A, fiber 150 may be buried under or near a roadway 140. One or more cars 130 drive over the roadway 140, and the cars generate seismic energy which can be considered a source that is used for geotechnical surveying according to the present disclosure.

The DFOS measurement is sensitive to the motion/deformation of the optical fiber 150, and hence the motion/deformation of the optical fiber's surroundings. For example, during an earthquake the soil will undergo compression and rarefaction as the seismic waves propagate through the near surface, and this motion will be transferred to the optical fiber 150.

The DFOS measurement can be made wherever a continuous optical fiber exists and can be connected at one end to a DFOS instrument 100. The fiber can be laid in any orientation, or even wrapped around a central cylinder in a helical fashion to introduce more than one component of motion/deformation to each gauge length of the DFOS measurement. Existing optical fiber laid for a different purpose can be utilized for the DFOS measurement. Multiple fibers can be joined in series and used for DFOS with one instrument, or multiple DFOS channels (analyzed with the same or separate DFOS instruments) can be used to record DFOS data within the same vicinity. It is advantageous to use existing telecommunications fibers which are already installed for DFOS measurements to conduct geotechnical surveying. Such an approach overcomes many of the disadvantages of other geotechnical surveying techniques noted above.

The optical fiber 150 can span a large distance in a geographic area, as shown by the trace 170 of the fiber 150 in the map of FIG. 1B. In embodiments, a bundle of optical fibers includes one or more fibers that are not normally used for communication, or are not allocated for use. The light can be injected into such fiber or fibers, also referred to as dark fibers. As shown in FIG. 1A, the source of seismic energy that is used for this process can be provided by man-made noise, such as vehicular traffic or natural energy such as from ocean waves. In embodiments, supplemental acoustic sources 120 may be used. The sources 120 may be positioned in an area of interest to generate energy that can be seen by the optical fiber. The sources 120 may be explosives, soil compactors, or other devices such as swinging a hammer, a tamper, or an air gun, among others.

The light can be any kind, including a simple pulse, chirped pulse, or continuous wave. In embodiments, the light is laser light. In further embodiments the laser light is in the infrared or near infrared frequency range. The energy returning from the optical fiber sensing path, indicated as arrows in FIG. 1A, may have been Rayleigh scattered as a result of the optical scattering properties along the length of the optical fiber, or the returning energy may have been caused by some Brilluoin or Raman transitions from the incident wavelength. The scattered light may be forward-scattered, back-scattered, or both.

The returning light can be analyzed optically, digitally, or both. The output of this process is a dataset, referred to here as the DFOS data or DFOS recording, which contains values about the state of the optical fiber for a particular time sample at all sensor positions in the fiber. It is also possible to imagine using telecommunication receiver statistics themselves for DFOS, without a dedicated instrument at one end, to extract information related to the fiber state, such as a property of polarization or time of flight from one end to the other which might carry information about the time-rate of change of fiber length, or state of stress or strain of the fiber at a point or over its length.

In an embodiment, the DFOS instrument can be an interrogator unit (“IU”) such as a unit for distributed acoustic sensing described in WO 2018/045433 A1, which is incorporated by reference in its entirety herein.

In some cases of DFOS there is not a physical fixed length sensor position. In principle, the gauge length is the distance along the optical fiber over which one DFOS value is sensitive. For example, in one type of pulsed Rayleigh-based DFOS the gauge length may be 10 m and the recorded data could be strain; in this case, the 10 m gauge length is the “reference length” over which displacements cause the resulting strain. The gauge length can affect many aspects of the measurement including the quality of the measurement, the gain of the measurement, the finest spatial size that can be analyzed without spatial aliasing, and the recorded DFOS data volume. The gauge length can be set in hardware and/or software. If the gauge length is established in software it may be possible to record DFOS data at multiple gauge lengths.

The DFOS measurement is sensitive to the motion/deformation of the optical fiber, and hence the motion/deformation of the optical fiber's surroundings. For example, during an earthquake the soil will undergo compression and rarefaction as the seismic waves propagate through the near surface, and this motion will be transferred to the optical fiber. When there is no large earthquake occurring, minute vibrations often referred to as “seismic noise” is present in the recordings because the self-noise of the DFOS measurement method is low. These background vibrations are a result of natural seismological processes like ocean wave interactions, tides, other small earthquakes, wind, and anthropogenic sources of seismic waves such as vehicles, trains, excavators, construction equipment, generators, hydrological pumps, alarms, and other human technology. Much of the seismic energy generated by these natural and anthropogenic processes propagates over 100's of kilometers before attenuating to a level where it can no longer be detected. For example, the seismic waves radiated by a moving freight train and wind turbines can be seen up to 40 kilometers from their sources.

In various embodiments, DFOS measurements made along the fiber path are correlated and the extracted coherent seismic wave background phase information (i.e., wave speed) is used to obtain near surface information below the segment of the telecommunication's optical fiber.

It is noteworthy that using DFOS differs from other approaches, such as discrete fiber Bragg grating sensing (FBG). In FBG a sensor or multiple sensors are added along an optical fiber, or a new optical fiber is used to connect multiple such sensors, and light is conveyed to the sensors. Such an approach is less desirable than DFOS because new sensors (and possibly new fiber) have to be added to existing telecommunications infrastructure, whereas in DFOS the existing optical fiber itself acts as the sensor, without the need to add any more sensors along the fiber or new fibers to the existing fibers. Moreover, the entire optical fiber is used as a sensor, so any position along the fiber selected for sensing, thus allowing to focus on specific geographic areas and locations along the fiber for geotechnical surveying.

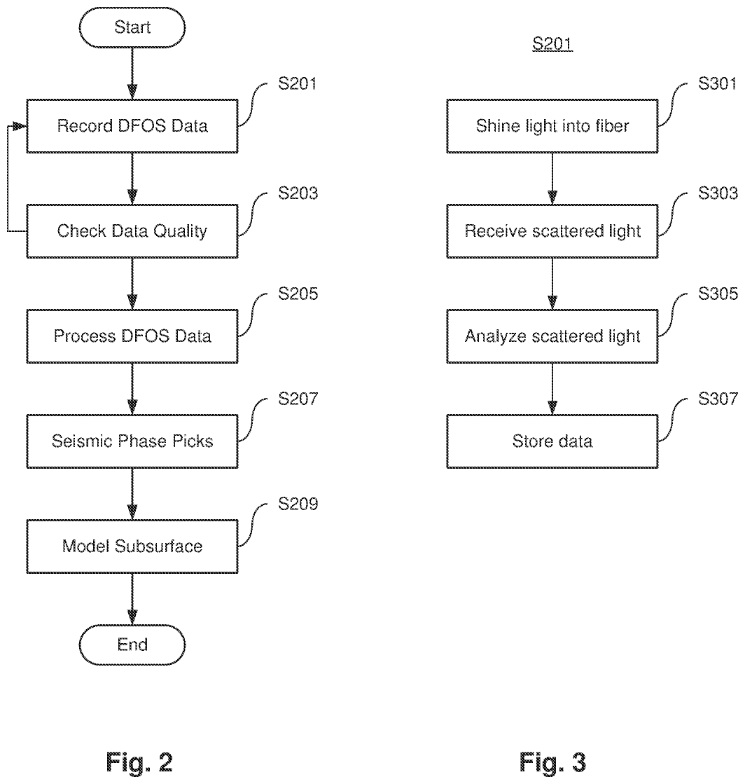

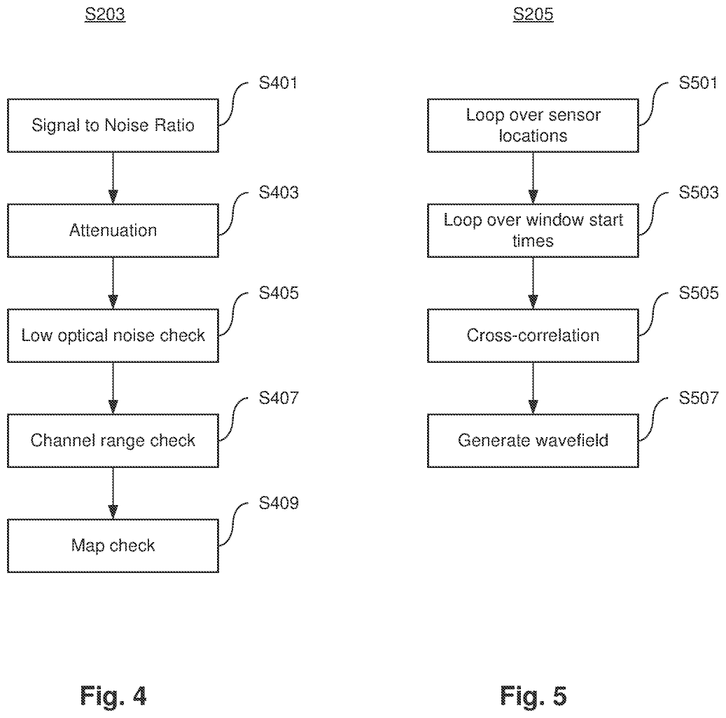

The disclosure highlights an example workflow algorithm which begins with the optical process and ends with subsurface property information. Referring to FIG. 2, an exemplary workflow algorithm for generating a geotechnical survey is shown. At S201, DFOS data is collected, as described below in greater detail with reference to FIG. 3. At S203, the collected data is checked to determine whether it satisfies certain quality parameters. If the collected data does not pass the data quality check, new data is recorded and stored. Additional details of the data quality check are described below with reference to FIG. 4. If the data passes the data quality check, the process continues at S205 with processing of the DFOS data, which is described in greater detail below with reference to FIG. 5.

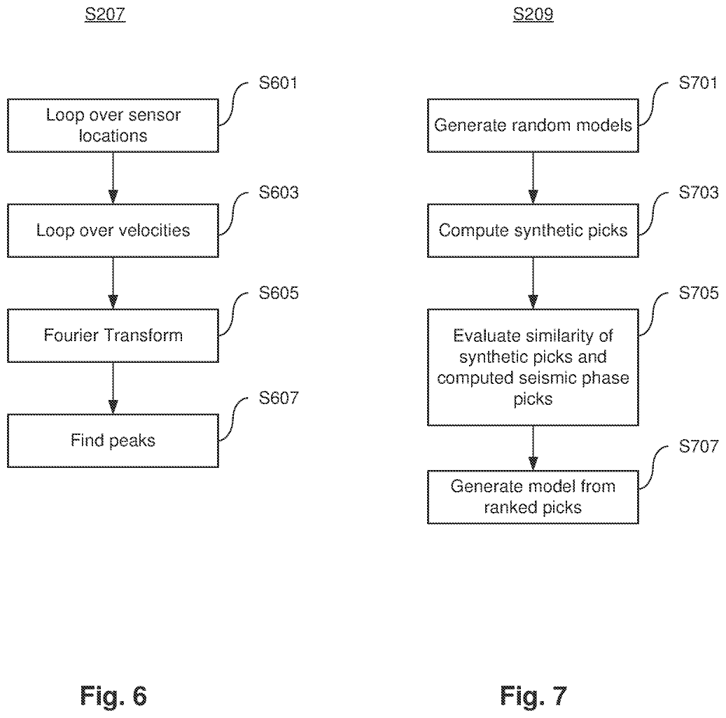

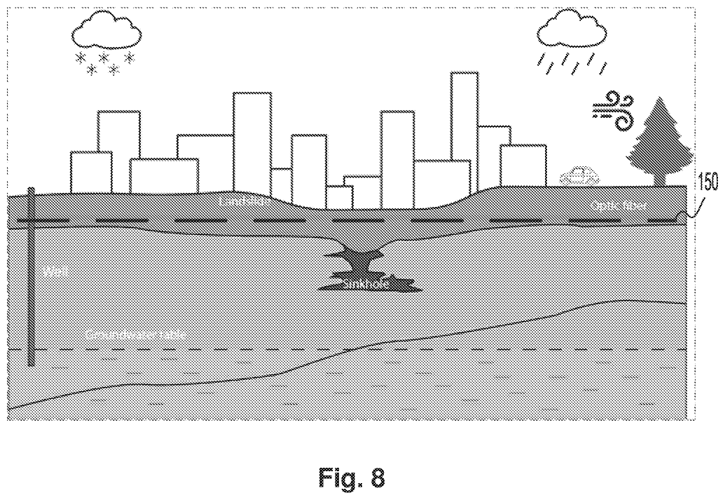

At S207, the process picks seismic phases from the output of S205, as described below in greater detail with reference to FIG. 6. At S209 the process models the subsurface of the area being studied, thereby generating the geotechnical survey, as described in greater detail below with reference to FIG. 7. Additional details of these processing steps are described below.

FIG. 3 provides additional details of exemplary embodiments for collecting DFOS data (FIG. 2, S201). It will be understood that the optical fiber is generally a part of existing infrastructure, such as a communication cable used to convey digital traffic encoded as light pulses. Often, such communication infrastructure includes a bundle of multiple optical fibers, with not all of them utilized. An unutilized optical fiber (i.e., dark cable) can be connected to a DFOS device, such that light can be emitted into the fiber and also received from the fiber.

The first step (S301) involves using a light emitting device to shine a light into an optical fiber, then receiving that light (S303) using a receiving device at the same or a different terminus of the optical fiber. In embodiments, the light emitting device is a laser emitter that is capable of emitting laser light. In embodiments, the emitted laser light is in a band of frequencies that span wavelengths of 1550-1580 nanometers. In further embodiments, a single frequency is used. In further embodiments, multiple frequency bands, that are separated from each other, are used.

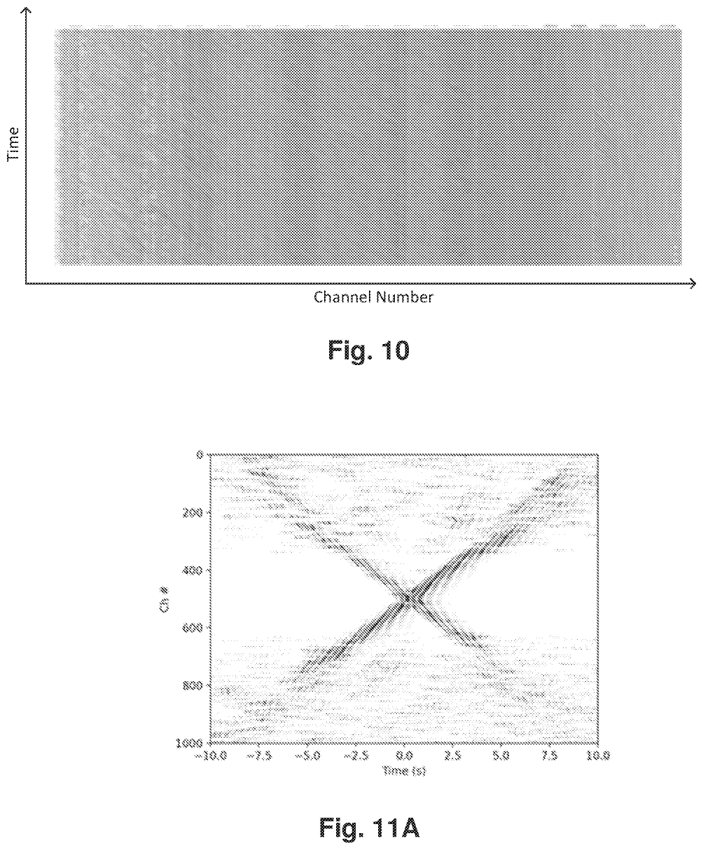

The result of S301 is a DFOS data stream which comprises the distributed vibration or temperature field acting on the optical fiber cable over some time interval. In DFOS, it is possible that the spatial sampling rate or spatial resolution is as small as millimeters to or up to kilometers. The time sampling rate can also range from microseconds to hours. The actual spatial and time sampling rates are software selectable and are selected to capture the ground motions in the subsurface—typically around 1 spatial sensing point every 1 meter along the fiber, and I data point in time every 0.1-0.001 s (10-1000 Hz). The second step in the algorithm is to record a subset of the DFOS data stream wherein it is desirable to determine subsurface properties. The recording consists of M sensing channels (positions in fiber) and T minutes of continuous data at S307. FIG. 10 illustrates an exemplary result of S307.

The optical fiber may be included as a part of a bundle of optical fibers that are used for communication, or other infrastructure purposes. In embodiments, the optical fiber into which the light is emitted is a dark fiber, meaning it is not normally used as part of the infrastructure purposes. In embodiments, multiple optical fibers are utilized in parallel, such that processing may be performed on each of the multiple fibers separately, with multiple geotechnical surveys resulting, that can be combined to improve accuracy. In further embodiments, multiple parallel optical fibers are used and data from the parallel fibers is combined at an early stage of processing (e.g., by averaging of values) to improve accuracy of the final geotechnical survey.

The step of subletting the dataset could also be accomplished without actually storing the subset dataset if enough RAM were available to store the dataset. The subset dataset may be all channels for a period of 6 hours, in which case M is equal to the number channels in the DFOS Data Stream (e.g., 12000) and T is equal to 2160.

Referring back to FIG. 2, a quality check takes place at S203. Details of an exemplary embodiment of S203 are illustrated in FIG. 4. If the quality check is passed then the workflow is permitted to continue with the subset dataset. If the quality check identified poor quality, then the workflow returns to the DFOS Data Stream and selects a new raw DFOS subset section. Any one of the following steps can be used as a criterion for discarding the recorded data and obtaining a new dataset. Although the process below is listed in a particular order, it will be understood that the following data quality checks can be performed in any order.

At S401, the signal to noise ratio of the recorded data is verified. The signal to noise ratio relates to the recovered fidelity of the vibrational signal above the optical noise floor. As the optical noise of DFOS is commonly found to vary over the range of the fiber-optic array, this step can be used to establish where there is usable data.

At S403, the attenuation characteristics of the data are verified by applying a statistical test of seismic attenuation to verify the signal is valid. For example, it is possible to fit a model of how seismic waves attenuate through the subsurface to the data, and then reject the subset data where the test failed.

At S405, the low optical noise check is performed by evaluating time-invariant optical noise characteristics. Alternatively, it is possible to filter out these effects.

At S407, the channel range check determines the linearity of the subset channels in order to determine if the curvature of the subset section is outside a range of usability.

At S409, the map check is used to verify that the selected optical fiber has a physical layout that does not preclude accurate measurements, such as being located inside of a pit or building or along a bridge, or being located far from seismic sources or too close to seismic sources. If the data quality check is satisfied, the processing continues to S205, with details shown in FIG. 5.

The overall processing in S205 can be thought of as seismic interferometry applied to segments in the DAS array (i.e., virtual sensor locations designated along the optical fiber). Seismic interferometry is a process wherein neighboring channels are cross-correlated against one channel. This step “enhances” coherent components and “reduces” incoherent components. That is why this process can also be thought of as seismic noise compression. The input is illustrated schematically in FIG. 10, with time on the vertical axis and channel number along the horizontal axis.

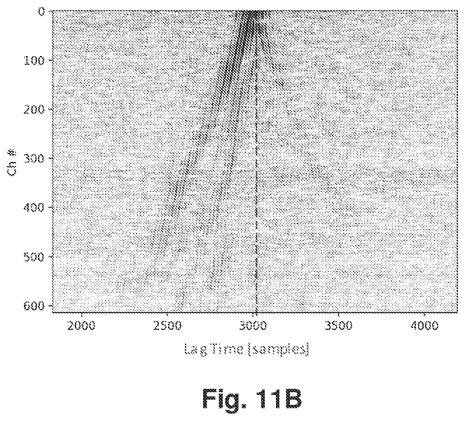

Data from N regularly or irregularly spaced sensors (where N<=M) is convolved with the neighboring P sensors and averaged over time in order to extract the coherent components from the background wavefield. The process loops over sensor locations at S501 and over window start times at S503. DFOS data for a particular sensor location and a particular time is cross-correlated at S505 with DFOS data for neighboring sensors and over multiple time windows. In embodiments, 1-minute cross-correlations are stacked over 3-hours until the “extraction” converges to a sharp image, such as shown in FIGS. 11A and 11B, which represent wavefields where coherent energy can be clearly seen.

More specifically, the result is a compressed wavefield dataset of size N×P.

The process of FIG. 2 then continues at S207 with picking of seismic phases, whose details are shown in FIG. 6. The change of seismic velocities within Earth, as well as the possibility of conversions between compressional (P) waves and shear (S) waves, results in many possible wave paths. Each path produces a separate seismic phase on seismograms. Referring to FIG. 6, a process of seismic phase picking is illustrated in schematic form. At a high level, this process applies multiple different seismological processing techniques to analyze, model and interpret the compressed wavefield data in terms of the subsurface property information. The process recognizes the dependence of velocity of seismic waves on the frequency of the wave. At most locations on the planet, seismic velocities increase as the depth increases due to consolidation of the materials. Higher frequency seismic waves (of relatively short wavelength) are more sensitive to the shallow layers, while lower frequency seismic waves (of relatively long wavelength) are more sensitive to the deeper layers.

Different processes in this step may yield different results, for example, a technique applied to surface wave analysis may yield subsurface property information related to shear wave speed (Vs) as a function of space (Z), while analysis of body wave information may yield subsurface property information related to compressional wave speed (Vp). Such information may be combined to yield a geotechnical survey report.

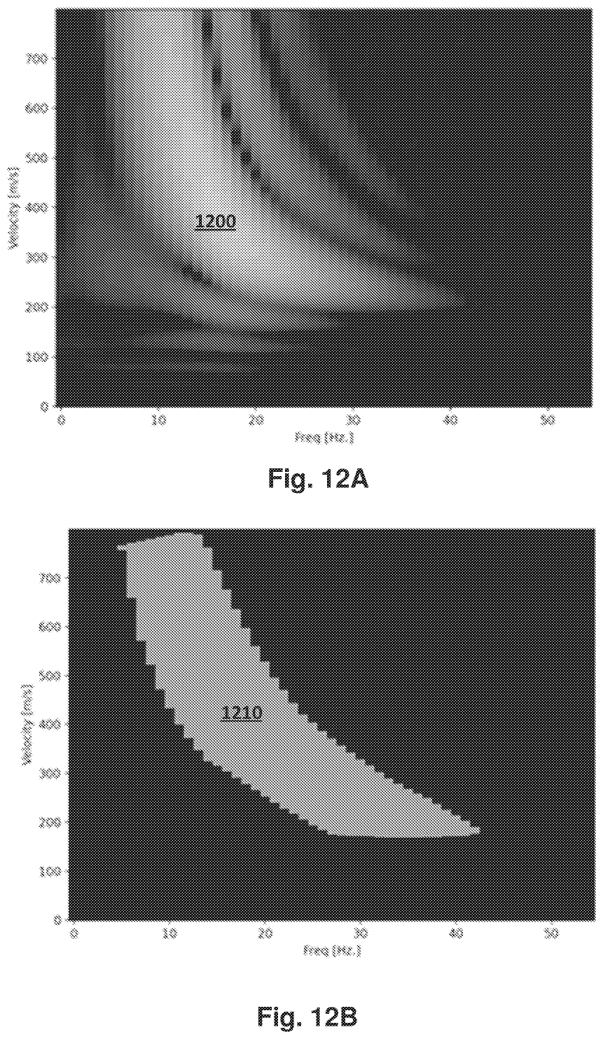

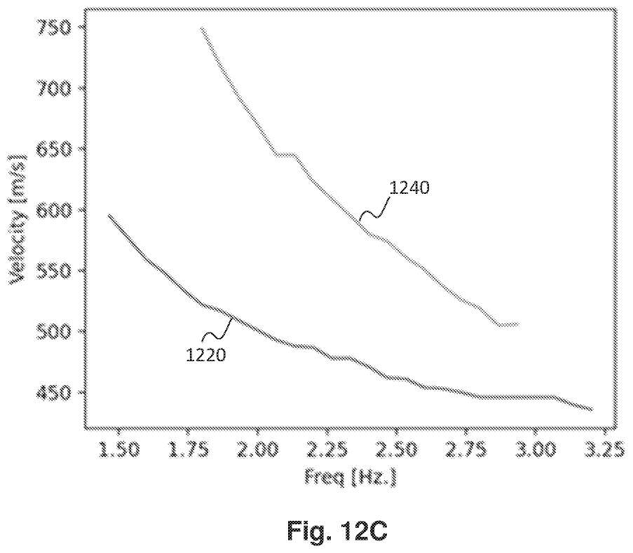

In an embodiment, the seismic phase picking process receives as input the wavefield dataset from S205, sensor locations, and lists of possible velocities of seismic waves in the area under study. The process loops over sensor locations at S601 and also loops over the velocities to create a table based on the wavefield and velocities of interest. This can be thought of as a grid search over the velocity list. At S605 a table of dispersions is calculated based on a Fourier transform (e.g., FFT) of the table noted above. An example of the resulting data set is illustrated in FIG. 12A, with velocities plotted against frequencies. This result can be thought of as wave speed for a set of frequencies seen by a particular sensor (i.e., portion of optical fiber.) The color in the plot represents velocity, with the brighter central region 1200 representing the highest velocities in the plot.

At S607, the seismic phase is picked by finding peaks in the data. FIG. 12B illustrates the data set of FIG. 12A after peak picking is applied, as only the highest energy levels are preserved as shown at 1210. This intermediate data is further processed, e.g., by applying a best fit method, to return a curve (or multiple curves 1220 and 1240) of velocity vs. frequency, as shown in FIG. 12C. In embodiments, the first 30 meters of depth at 10 Hz is of interest, which corresponds to the VS30 data, which is defined as the average seismic shear-wave velocity from the surface to a depth of 30 meters. At this measurement depth, the optical fiber depth does not significantly affect the measurements.

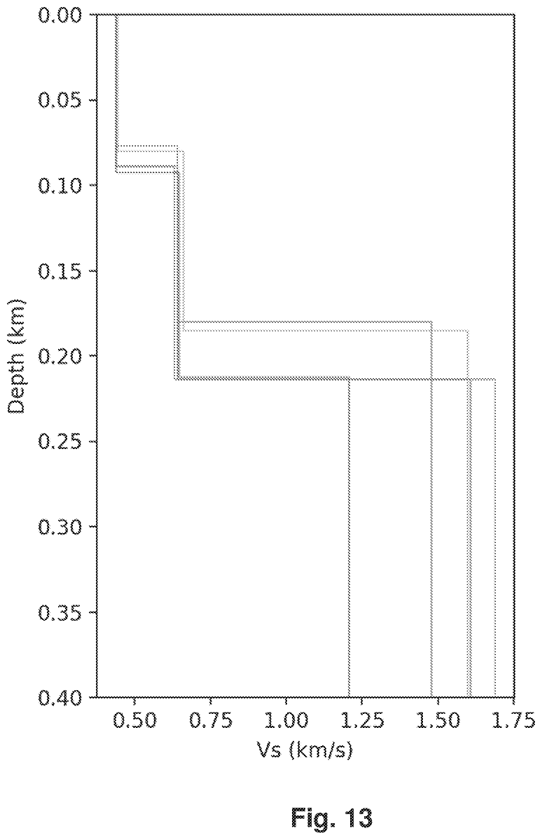

The process then continues at S209, where the subsurface is modeled based on the seismic phases picked at S207. The details of S209 are shown in FIG. 7. Conceptually, the process inverts for 1-D models of shear wave speed that represent the subsurface geology. The process may use Markov Chain Monte Carlo to efficiently search over the possible model parameter space, to identify the best fitting final model family, as shown by the result of the process in FIG. 13.

Turning to FIG. 7, at S701, a set of models is generated, considering the wave velocity of various subsurface layers, shown in FIG. 15. In embodiments, the number of models is 100,000 or less. These models are then used to compute synthetic seismic phase picks at S703. At S705, the synthetic seismic phase picks are compared to the computed phase picks from S207. Using a method, such as RMS to minimize error, the most similar synthetic phase picks are selected.

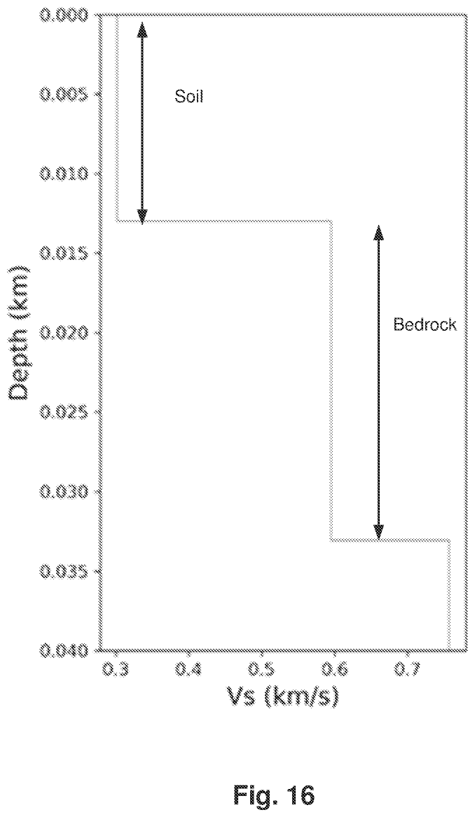

At S707, a model of depth vs wave speed is generated based on the selected synthetic phase picks, as shown in FIG. 13. The model in FIG. 13 can further be refined by e.g., averaging the wave speed vs. depth lines into a single line, and mapping actual substrate substance to each wave speed based on known characteristics of substrates, as shown in FIG. 16.

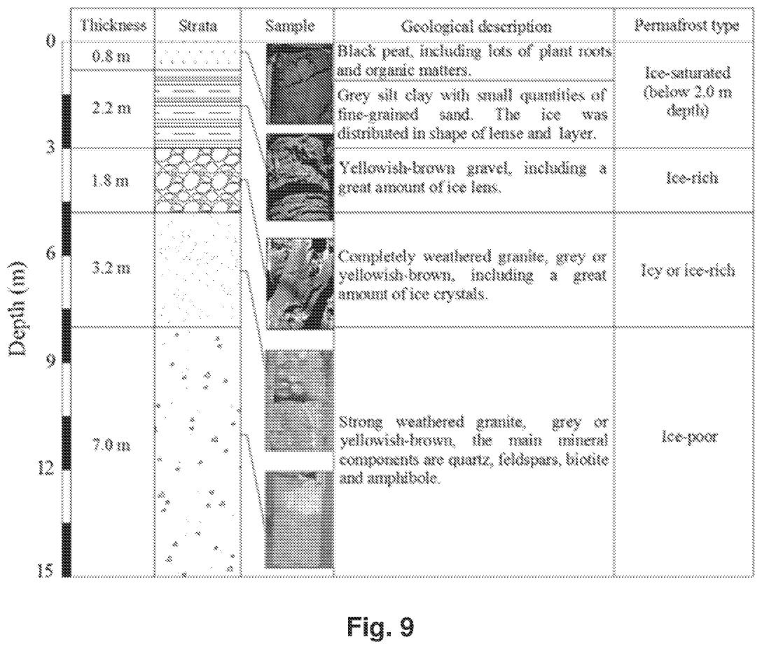

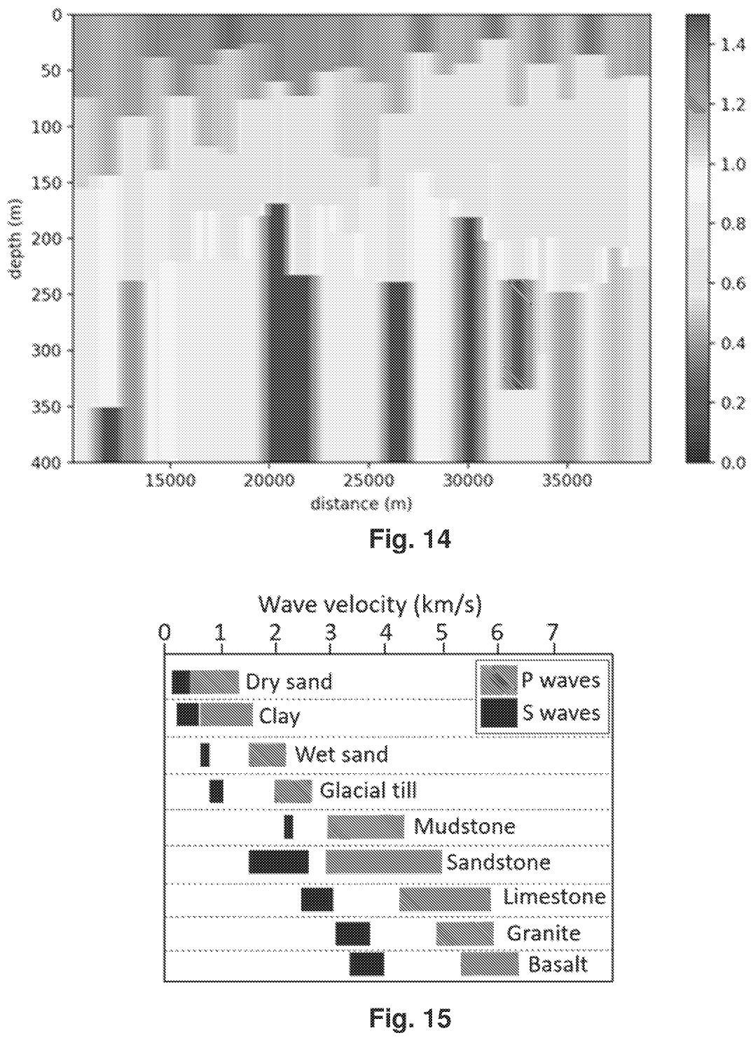

The result in FIGS. 13 and 16 represents the undersurface conditions at a particular sensor location (i.e., segment of the optical fiber). These locations can be combined to illustrate the subsurface conditions over a long span of the optical fiber, as shown in FIG. 14. Here, the color of each pixel represents the wave velocity in Km/s. It is apparent from the example in FIG. 14, that three different substrates, each having a range of wave velocities, extend in the studied area at varying depths. The abrupt change in wave velocity (color in the plot) in a particular column represents a boundary between two discrete layers of substrate. This result can be considered the final result, or can be further parsed into data such as shown in FIG. 9.

Further embodiments are as follows. According to a first further embodiment, there is provided a method of generating a geotechnical survey of a target area, comprising measuring DFOS data in an optical fiber located within a sensing distance of the target area; and determining subterranean characteristics of the target area based on the measured DFOS data. According to a second further embodiment, there is provided the method of the first further embodiment, wherein the measuring of the DFOS data includes measuring strain induced in a fiberoptic cable. According to a third further embodiment, there is provided the method of the first further embodiment, wherein the measuring of the DFOS data includes cross-correlating neighboring channels against one channel to amplify coherent noise components and suppress incoherent noise components. According to a fourth further embodiment, there is provided the method of the third further embodiment, wherein the measuring of the DFOS data further includes stacking time segments of duration T1 of cross-correlations over a total duration T2, longer than T1.

According to a fifth further embodiment, there is provided the method of the second further embodiment, wherein the strain is induced in the fiberoptic cable by background seismic noise. According to a sixth further embodiment, there is provided the method of the fifth further embodiment, wherein the background seismic noise is caused by at least one of generators, vehicles, construction and excavation equipment, pumps, machinery, infrastructure, wind, and ocean waves. According to a seventh further embodiment, there is provided the method of the second further embodiment, wherein the determining subterranean characteristics of the target area based on the measured DFOS data includes measuring seismic wave velocity as a function of frequency. According to an eight further embodiment, there is provided the method of the first further embodiment, wherein the determining subterranean characteristics of the target area based on the measured DFOS data includes modeling subsurface geological layers under the fiberoptic cable based on the wave velocity calculated as a function of frequency. According to a ninth further embodiment, there is provided the method of the seventh further embodiment, wherein the measuring seismic wave velocity includes extracting coherent surface waves at a predetermined spatial resolution.

According to a tenth further embodiment, there is provided the method of the ninth further embodiment, wherein the determining subterranean characteristics of the target area further includes modeling subsurface layers based on frequency dependence of velocity of seismic waves at multiple depths. According to an eleventh further embodiment, there is provided the method of the tenth further embodiment, wherein the determining subterranean characteristics of the target area further includes inverting for 1-D models of shear wave speed that represent subsurface geology by applying Markov Chain Monte Carlo to search over a possible model parameter space. According to a twelfth further embodiment, there is provided the method of the second further embodiment, wherein the determining subterranean characteristics of the target area based on the measured DFOS data includes measuring seismic wave velocity as a function of offset. According to a thirteenth further embodiment, there is provided the method of the twelfth further embodiment, wherein the determining subterranean characteristics of the target area further includes modeling subsurface layers based on measuring the travel time of seismic waves that penetrate the subsurface. According to a fourteenth further embodiment, there is provided the method of the twelfth further embodiment, wherein the determining subterranean characteristics of the target area further includes modeling subsurface layers based on measuring the attenuation of seismic waves that penetrate the subsurface.

According to a fifteenth further embodiment, there is provided the method of the tenth further embodiment, wherein the determining subterranean characteristics of the target area further includes inverting for 1-D models of compressional wave speed and/or shear wave speed that represent subsurface geology by applying seismic tomography. According to a sixteenth further embodiment, there is provided the method of the tenth further embodiment, wherein the determining subterranean characteristics of the target area further includes calculating a ratio of compressional and shear wave speeds. According to a seventeenth further embodiment, there is provided the method of the first further embodiment, further comprising connecting a DFOS device to the optical fiber, wherein the measuring the DFOS data includes transmitting light from the DFOS device into the optical fiber and receiving refracted light from the optical fiber. According to an eighteenth further embodiment, there is provided the method of the first further embodiment, wherein the measuring of the DFOS data includes measuring strain. According to a nineteenth further embodiment, there is provided the method of the first further embodiment, wherein the measuring of the DFOS data includes measuring ground motion.

According to a twentieth further embodiment, there is provided the method of the first through sixteenth further embodiments, further comprising providing active seismic sources in a sensing range of the optical fiber; and emitting seismic energy from the active sources. According to a twenty first further embodiment, there is provided the method of the first through seventeenth further embodiments, wherein the survey result in one-dimensional. According to a twenty second further embodiment, there is provided the method of the first through seventeenth further embodiments, wherein the survey result in a two-dimensional profile of the subsurface along the fiber path. According to a twenty third further embodiment, there is provided the method of the first through seventeenth further embodiments, wherein the survey result in three-dimensional. According to a twenty fourth further embodiment, there is provided the method of the twenty third further embodiment, wherein the result is a subsurface volume with layers and isopachs across region. According to a twenty fifth further embodiment, there is provided the method of the first through twenty first further embodiments, wherein the optical fiber is installed in a horizontal fashion underwater, either on top of or below the seafloor.

According to a twenty sixth further embodiment, there is provided a DFOS device, comprising a light transmitter configured to transmit light into an optical fiber; a receiver configured to receive light from the optical fiber; and a controller configured to execute a method as defined in any of the first through twenty fifth further embodiments.

According to a twenty seventh further embodiment, there is provided a system for processing earthquake data, comprising one or more DFOS devices according to the twenty sixth further embodiment; and one or more optical fibers operatively connected to the one or more DFOS devices.

According to a twenty eighth further embodiment, there is provided the method of the first through twenty fifth further embodiments, wherein the survey result is lithological information in the upper 50 m, including rock and soil type, layer thicknesses and layer depths. According to a twenty ninth further embodiment, there is provided the method of the first through twenty fifth further embodiments, wherein the survey result is physical parameters, including density, shear modulus, bulk modulus, Poisson's ratio, Vp/Vs ratios, saturation, layer thicknesses and layer depths. According to a thirtieth further embodiment, there is provided the method of the first through twenty fifth further embodiments, wherein the survey result is Vs30 values or a different statistical representation of seismic shear wave speed information (average or weighted average or median of the seismic shear wave speed in the upper 30, 40, 50 meters, for example). According to a thirty first further embodiment, there is provided the method of the first through twenty fifth further embodiments, wherein the survey result is hydrological information, including water table depth, recharge state, hydrological stage of health, total available water volume, water banking volume, infiltration rate.

According to a thirty second further embodiment, there is provided the method of the first through twenty fifth further embodiments, wherein the survey result is deep soundings at >150 m depth. According to a thirty third further embodiment, there is provided the method of the first through twenty fifth further embodiments, wherein the survey result is a measurement of depth of cover of the optical fiber. According to a thirty fourth further embodiment, there is provided the method of the first through thirtieth further embodiments, wherein the recorded signals used for the geotechnical survey are natural seismic energy and artificially created seismic energy. According to a thirty fifth further embodiment, there is provided the method of the first through thirtieth further embodiments, wherein the recorded signals used for the geotechnical survey are natural seismic energy. According to a thirty sixth further embodiment, there is provided the method of the first through thirtieth further embodiments, wherein the recorded signals used for the geotechnical survey are artificially created seismic energy.

According to a thirty seventh further embodiment, there is provided a geotechnical surveying system, comprising a DFOS device that includes a light transmitter configured to transmit light into an optical fiber, a receiver configured to receive light from the optical fiber, and a controller configured to execute a method as defined in any of the first through twenty second further embodiments. According to a thirty eighth further embodiment, there is provided the system of the thirty seventh further embodiment, further comprising the optical fiber. According to a thirty ninth further embodiment, there is provided the system of the thirty eighth further embodiment, wherein the optical fiber is a part of a fiber bundle used for communication. According to a fortieth further embodiment, there is provided the system of the thirty seventh further embodiment, further comprising at least one active seismic source configured to generate and output seismic energy into ground to generate seismic waves that are detectable by the DFOS device.

According to a forty first further embodiment, there is provided the system of the thirty seventh further embodiment, wherein the survey result is lithological information in the upper 50 m, including rock and soil type, layer thicknesses and layer depths.

According to a forty second further embodiment, there is provided the system of the thirty seventh further embodiment, wherein the survey result is physical parameters, including density, shear modulus, bulk modulus, Poisson's ratio, Vp/Vs ratios, saturation, layer thicknesses and layer depths. According to a forty third further embodiment, there is provided the system of the thirty seventh further embodiment, wherein the survey result is Vs30 values or a different statistical representation of seismic shear wave speed information (average or weighted average or median of the seismic shear wave speed in the upper 30, 40, 50 meters, for example). According to a forty fourth further embodiment, there is provided the system of the thirty seventh further embodiment, wherein the survey result is hydrological information, including water table depth, recharge state, hydrological stage of health, total available water volume, water banking volume, infiltration rate. According to a forty fifth further embodiment, there is provided the system of the thirty seventh further embodiment, wherein the survey result is deep soundings at >150 m depth.

According to a forty sixth further embodiment, there is provided the system of the thirty seventh further embodiment, wherein the survey result is a measurement of depth of cover of the optical fiber. According to a forty seventh further embodiment, there is provided the system of the thirty seventh further embodiment, wherein the recorded signals used for the geotechnical survey is natural seismic energy generated by at least one of ocean waves, wind, vehicles, infrastructure, and/or buildings. According to a forty eighth further embodiment, there is provided the system of the fortieth further embodiment, wherein the at least one active seismic source includes swinging a hammer, or using a tamper, air gun, or explosive. According to a forty nineth further embodiment, there is provided the system of the thirty seventh through forty eighth further embodiments, wherein the recorded signals used for the geotechnical survey are natural seismic energy and artificially created seismic energy.

It is, thus, apparent that there are provided, in accordance with the present disclosure, distributed fiber-optic sensing systems, devices, and methods that provide scalable telecommunications geotechnical surveying. Many alternatives, modifications, and variations are enabled by the present disclosure. Features of the disclosed embodiments can be combined, rearranged, omitted, etc., within the scope of the invention to produce additional embodiments. Furthermore, certain features may sometimes be used to advantage without a corresponding use of other features. Accordingly, Applicants intend to embrace all such alternatives, modifications, equivalents, and variations that are within the spirit and scope of the present invention.

What is claimed is:

1. A method of generating a geotechnical survey of a target area, comprising:
measuring DFOS data in an optical fiber located within a sensing distance of the target area; and
determining subterranean characteristics of the target area based on the measured DFOS data.

2. The method of claim 1, wherein the measuring of the DFOS data includes measuring at least one of: strain; strain rate; velocity; displacement; pressure; motion; acceleration induced in the optical fiber.

3. The method according to claim 2, wherein the measuring of the DFOS data includes:
cross-correlating neighboring channels against one channel to amplify coherent noise components and suppress incoherent noise components; and
stacking time segments of duration T1 of cross-correlations over a total duration T2, longer than T1.

4. The method according to claim 2, wherein:
the strain is induced in the optical fiber by background seismic noise; and
the background seismic noise is caused by at least one of generators, vehicles, construction and excavation equipment, pumps, machinery, infrastructure, wind, and ocean waves.

5. The method according to claim 2, wherein the determining subterranean characteristics of the target area based on the measured DFOS data includes:
measuring seismic wave velocity as a function of frequency; and
modeling subsurface geological layers under the optical fiber based on the wave velocity calculated as a function of frequency.

6. The method according to claim 5, wherein the measuring seismic wave velocity includes extracting coherent surface waves at a predetermined spatial resolution; and the determining subterranean characteristics of the target area further includes one of:
modeling subsurface layers based on frequency dependence of velocity of seismic waves at multiple depths;
inverting for 1-D models of shear wave speed that represent subsurface geology by applying Markov Chain Monte Carlo to search over a possible model parameter space;
inverting for 1-D models of compressional wave speed and/or shear wave speed that represent subsurface geology by applying seismic tomography; and
calculating a ratio of compressional and shear wave speeds.

7. The method according to claim 2, wherein the determining subterranean characteristics of the target area based on the measured DFOS data includes at least one of:
measuring seismic wave velocity as a function of offset; and
modeling subsurface layers based on measuring a travel time or an attenuation of seismic waves that penetrate a subsurface.

8. The method of claim 1, further comprising:
connecting a DFOS device to the optical fiber,
wherein the measuring the DFOS data includes transmitting light from the DFOS device into the optical fiber and receiving refracted light from the optical fiber.

9. The method of claim 1, wherein the measuring of the DFOS data includes measuring at least one of strain and ground motion.

10. The method of claim 1, further comprising:
providing active seismic sources in a sensing range of the optical fiber; and
emitting seismic energy from the active seismic source.

11. The method of claim 1, wherein a survey result in a two-dimensional profile of a subsurface along a path of the optical fiber.

12. The method of claim 1 wherein a survey result in three-dimensional, and is a subsurface volume with layers and isopachs across region.

13. The method of claim 1, wherein the optical fiber is installed in a horizontal fashion underwater, either on top of or below a seafloor.

14. The method of claim 1, wherein a survey result is lithological information in an upper 50 m, including rock and soil type, layer thicknesses and layer depths.

15. The method of claim 1, wherein a survey result is physical parameters, including density, shear modulus, bulk modulus, Poisson's ratio, Vp/Vs ratios, saturation, layer thicknesses and layer depths.

16. The method of claim 1, wherein a survey result is Vs30 values or a different statistical representation of seismic shear wave speed information.

17. The method of claim 1, wherein a survey result is hydrological information, including water table depth, recharge state, hydrological stage of health, total available water volume, water banking volume, infiltration rate.

18. The method of claim 1, wherein recorded signals used for the geotechnical survey are at least one of natural seismic energy and artificially created seismic energy.

19. A geotechnical surveying system, comprising:
a DFOS device that includes a light transmitter configured to transmit light into an optical fiber, a receiver configured to receive light from the optical fiber, and a controller configured to execute a method of generating a geotechnical survey of a target area, the method further comprising:
measuring DFOS data in an optical fiber located within a sensing distance of the target area; and
determining subterranean characteristics of the target area based on the measured DFOS data.

20. A DFOS device, comprising:
a light transmitter configured to transmit light into an optical fiber;
a receiver configured to receive light from the optical fiber; and
a controller configured to execute a method of generating a geotechnical survey of a target area, the method further comprising:
measuring DFOS data in an optical fiber located within a sensing distance of the target area; and
determining subterranean characteristics of the target area based on the measured DFOS data.
